(19) United States
(12) Patent Application Publication
(10) Pub. No.: US 2009/0193356 A1
(43) Pub. Date: Jul. 30, 2009

(54) Systems and methods for providing a zoomable user interface

(75) Inventor: Nelson Saba, Orlando, FL (US)

Correspondence Address: CARR & FERRELL LLP, 2200 GENG ROAD, PALO ALTO, CA, 94303, US

(73) Assignee: Immersion Digital LLC

(21) Appl. No.: 12/322,081

(22) Filed: Jan. 28, 2009

Related U.S. Application Data
(60) Provisional application No. 61/062,749, filed on Jan. 28, 2008.

(51) Int. Cl. G06F 3/048

(52) U.S. Cl. 715/801

(57) ABSTRACT

Systems and methods for providing a zoomable user interface are provided. Objects associated with content may be graphically presented to a user. The graphical presentation may be initially based on a first browsing mode of a plurality of browsing modes. A selection of a portion of the objects of the graphical presentation may be received. In addition, a second or successive browsing mode may be determined. The selected portion may then be mapped based on the second browsing mode. Subsequently, the selected portion may be graphically presented based on the second browsing mode to the user.

### CROSS-REFERENCE TO RELATED APPLICATIONS

The present application claims the priority benefit of U.S. Provisional Patent Application No. 61/062,749 filed Jan. 28, 2008 and entitled “Zoomable User Interface System and Method,” the subject matter of which is incorporated herein by reference.

### BACKGROUND OF THE INVENTION

1. Field of Invention

The present invention relates generally to graphical environments and more particularly to providing a zoomable user interface.

2. Description of Related Art

In computing environments, a zoomable user interface (ZUI) is a graphical representation or display where users can alter a field of view of a virtual space, or ZUI space, in order to see more or less detail. In general, ZUI spaces include on-screen work areas that use icons and menus to simulate the top of a desk. Two popular examples of zoomable user interfaces include Google Earth® and Microsoft Virtual Earth®. These examples allow users to pan across virtual maps in two dimensions and zoom into objects of interest, thus enhancing the detail of those objects.

Information elements representing content of many different types, such as photos, videos, and articles, may be placed within the ZUI space. These information elements may appear directly within the ZUI space rather than in various windows, such as in a traditional graphical user interface (GUI). As such, users can pan across the ZUI space and zoom into information elements of interest. In one example, a text document placed within the ZUI space of the zoomable user interface may initially be represented as a small dot. Then, as a user zooms closer and closer into the text document, the text document may be represented as a thumbnail of a page of text, followed by a full-sized page, and finally a magnified view of the page.

In general, a conventional zoomable user interface allows users to browse large collections of information, but does not offer good mechanisms for visually locating specific information elements in those large collections.

### SUMMARY OF THE INVENTION

Embodiments of the present invention overcome or substantially alleviate prior problems associated with zoomable user interfaces, particularly with respect to locating information. In exemplary embodiments, a method for providing a zoomable user interface may include graphically presenting objects associated with content to a user. The graphical presentation may be initially based on a first browsing mode of a plurality of browsing modes. A selection of a portion of the objects of the graphical presentation may be received. A second or successive browsing mode may be determined in exemplary embodiments. In alternative embodiments, a selection of a second browsing mode may be received together with, or separate from, the selection of the portion of the objects. The method may further include mapping the selected portion based on the second browsing mode. Accordingly, the selected portion may be graphically presented based on the second browsing mode. This method may be performed recursively in accordance with exemplary embodiments.

In addition, the exemplary method for providing a zoomable user interface may include triggering a listing of the plurality of browsing modes available to the user. The second browsing mode or other successive browsing modes may be selected from the listing. Furthermore, the method may include filtering the objects based on a content type associated with each of the objects.

Further embodiments include a system for providing a zoomable user interface. The system may include an interface module configured to graphically present objects associated with content to a user. The graphical presentation may be based on any one of a plurality of browsing modes. The system may further include a selection module configured to receive a selection of a portion of the objects of the graphical presentation, a browser manager configured to manage browsing modes, and a coordinator module configured to map the selected portion based on the browsing mode determined by the browser manager.

Embodiments of the present invention may further include computer-readable storage media having embodied thereon programs that, when executed by a computer processor device, perform methods associated with providing a zoomable user interface.

### BRIEF DESCRIPTION OF THE DRAWINGS

FIG. 1 is an environment in which embodiments of the present invention may be practiced.

FIG. 2 is a block diagram of an exemplary zoomable user interface engine.

FIG. 3 is a flow chart of an exemplary method for providing a zoomable user interface.

FIGS. 4A, 4B, 4C, and 4D illustrate graphical presentations based on various browsing modes in accordance with exemplary embodiments.

FIG. 5 shows an exemplary digital device.

### DESCRIPTION OF EXEMPLARY EMBODIMENTS

The present invention provides exemplary systems and methods for providing a zoomable user interface. In exemplary embodiments, the zoomable user interface allows a user to visually locate specific elements included in a vast collection of information or content. The user may narrow the field of view of a ZUI space or other graphical presentation through invocation of multiple browsing modes, in addition to panning and zooming. These browsing modes may include one or more geographical modes, chronological modes, canonical modes, topical modes, content type based modes, or relational modes, in accordance with exemplary embodiments. Other browsing modes may also be utilized in some embodiments. Each browsing mode results in organization and display of objects representing the content, or portions thereof, according to different criteria with each successive selection of objects.

According to exemplary embodiments, zooming abilities associated with the zoomable user interface may include a combination of vector-based zooming capabilities and bitmap-based zooming capabilities. In exemplary embodiments, objects at a distance may be represented in a bitmap view (i.e., using pixels). However, as a user zooms in, the objects may be presented in a vector-based view which provides more detail to the objects. As such, rather than obtaining a pixilated appearance during zoom-in operations, the graphical presentation of the zoomable user interface may increase in level of detail.

In exemplary embodiments, the user may make various refinements to the content represented in the zoomable user interface. The user may identify a selection of objects representing a portion of the content and/or switch between browsing modes. Through a sequence of such refinements or selections, the user may narrow the initial vast content collection down to a specific subset of which the user is interested. Furthermore, in some embodiments, the user may determine which content types or forms of media are displayed by the zoomable user interface. As the collection of information is narrowed down through successive refinements or selections, the information within the collection becomes more detailed. Contrary to prior art systems which simply zoom into a single view or display, embodiments of the present invention alter the display and content based on the selection and browsing mode, as will be discussed further herein. For example, a timeline presented by the zoomable user interface may show entries that correspond to each year. As the timeline is zoomed-in on, entries corresponding to each month may appear, followed by entries corresponding to days and so on.

Exemplary embodiments of the present invention are illustrated using various examples below. However, embodiments of the present invention may be applied to any collection of content of which enough semantic information is available that allows the content to be visually organized according to multiple browsing modes. The collection of content may include one or more of a one-dimensional collection such as an ordered sequence, a two-dimensional collection such as a table or hierarchy, or a three-dimensional collection such as a three-dimensional chart or matrix. Embodiments of the present invention allow the user to visually navigate the collection of content despite the size of the collection. As the user browses the content in various browsing modes, makes selections, and switches to other browsing modes, the same browsing and refinement processes described herein with respect to the various examples will take place.

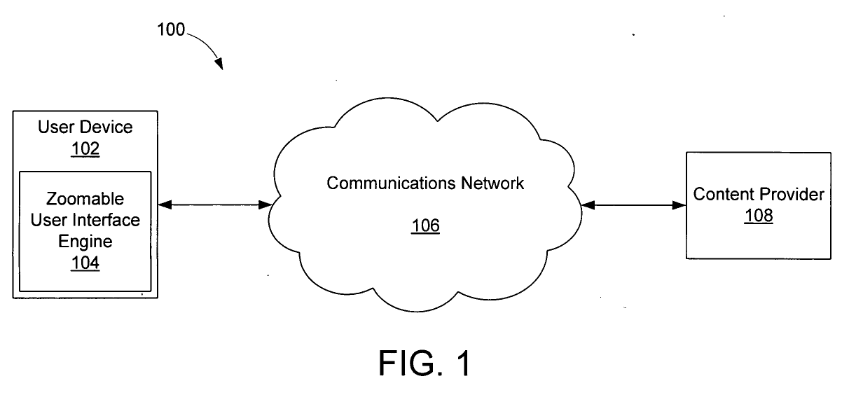

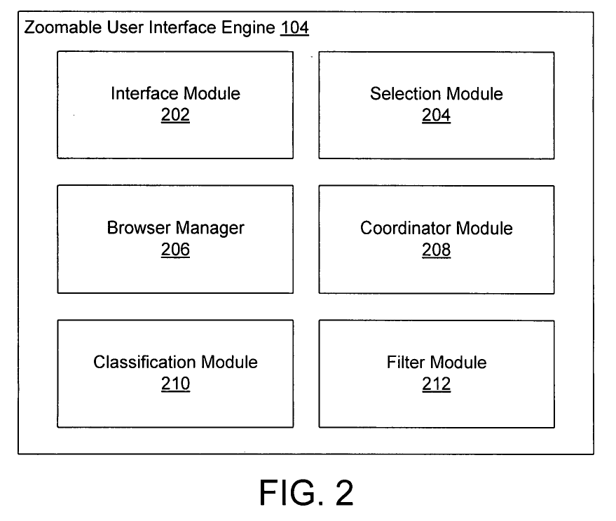

Referring now to FIG. 1, an environment 100 is illustrated in which embodiments of the present invention may be practiced. The environment 100 includes at least one user device 102 which, in turn, includes a zoomable user interface engine 104 configured to provide a zoomable user interface. The user device 102 is coupled in communication with a communications network 106. The communications network 106 may include, for example, a telecommunications network, a cellular phone network, a local area network (LAN), a wide area network (WAN), an intranet, and the Internet. The zoomable user interface engine 104 included in the user device 102 will be discussed in more detail in connection with FIG. 2 below. Although the user device 102 is discussed herein, any type of digital device may be utilized in conjunction with the zoomable user interface engine 104 to provide a zoomable user interface according to various embodiments.

A content provider 108 may be accessed by the user device 102 via the communications network 106. The content provider 108 may include any source of digital content which a user is interested in viewing or searching through. Any number of content providers 108 may be coupled via the communications network 106 to the user device 102.

It should be noted that FIG. 1 is an exemplary embodiment. Alternative embodiments may not utilize the communications network 106 or the content provider 108. In such embodiments, content may be stored locally by the user device 102, as discuss further herein. Additionally any number of user devices 102 and content providers 108 may be present in the environment 100.

FIG. 2 is a block diagram of an exemplary zoomable user interface engine 104. The zoomable user interface engine 104 may comprise an interface module 202, a selection module 204, a browser manager 206, a coordinator module 208, a classification module 210, and a filter module 212. Although FIG. 2 describes the zoomable user interface engine 104 as including various modules and elements, fewer or more modules or elements may comprise the zoomable user interface engine 104 and still fall within the scope of various embodiments.

The zoomable user interface engine 104 may be comprised of software or firmware that, when executed by a processor, directs a digital device (e.g., the user device 102) to operate in accordance with exemplary embodiments. Such software or firmware may be provided to the digital device by disk (e.g., DVD or CD) or by download, in accordance with exemplary embodiments. For example, the first time a user device 102 is used to access a zoomable search engine at a content provider 108, the software may be downloaded to the user device 102. In further embodiments, such software or firmware may be stored remotely and accessed via the communications network 106 by the user device 102.

The interface module 202 may be configured to graphically present objects associated with content to a user. In some embodiments, the graphical presentation may be in the form of a ZUI space. The objects may include shapes, icons, thumbnail views, or other representations of the content. The content may comprise any type of digital media, such as text, photos, videos, audio recordings, maps, articles, third party content, and so on. For example, an article on Egypt may be represented by an image of the flag of Egypt or a map outline of Egypt placed within the ZUI space. Additionally, the graphical presentation may be based on any one of a plurality of browsing modes, as described further herein.

In some embodiments, the interface module 202 provides further capabilities in viewing and visually presenting the content. For instance, the interface module 202 may be configured to present the content itself. In one embodiment, a user may click on an object representing content, such as the image of the flag of Egypt mentioned above, and the corresponding content may appear in a window or bubble above the ZUI space. Alternatively, an appropriate application corresponding to a type of content may be launched when the object representing that content is clicked. For example, if an object representing a text document is clicked, a word processing program (e.g., Microsoft Word or Corel WordPerfect) may be launched to view the text document. The appropriate application may be launched separate from the zoomable user interface (e.g., in a new window) or in conjunction with the zoomable user interface (e.g., in a pop-up window). Furthermore, the interface module 202 may also be configured to allow the user to alter the field of view of the graphical presentation, such as by zooming or panning.

The selection module 204 may be configured to receive a selection of a portion of the objects of the graphical presentation. In exemplary embodiments, the portion of objects may be selected by the user utilizing a selection device, such as a mouse or stylus. In one example, a user may specify the portion of the objects by drawing a box around desired objects. Alternative selection means and mechanisms may also be utilized. The selection of the portion of the objects may be used by the other modules and elements included in the zoomable user interface engine 104 in order to locate and visually present specific content included in vast content collections.

The exemplary browser manager 206 may be configured to manage display of a determined browsing mode. Specifically, the browser manager 206 may determine the browsing mode to be utilized by the interface module 202 and control generation of the browsing mode. It is noted that the browsing mode may be associated with certain criteria. As mentioned above, any such criterion may be associated with, for example, geography, chronology, canons, topics, or relationships. To illustrate, an example involving five independent events is considered. A geographical browsing mode (i.e., a browsing mode associated with geographical criteria) may result in the interface module 202 presenting the five events based on locations where the events took/takes place. For instance, the graphical presentation may include a map with objects, such as icons, marking the location of each of the events. A chronological browsing mode (i.e., a browsing mode associated with chronological criteria), on the other hand, may result in the interface module 202 presenting the five events on a timeline according to when each event took/takes place. According to various embodiments, the browser manager 206 may also control one or more functions performed by the coordinator 208 including mapping to generate the correct browsing mode.

In some embodiments, the browser manager 206 may be further configured to trigger a listing of the plurality of browsing modes to be provided to the user. Accordingly, a user of the user device 102 may select the browsing mode from this listing. Certain actions by the user may cause the listing to be triggered. For example, selection of the portion of the objects graphically presented by the interface module 202 may result in the automatic triggering of the listing. In one embodiment, the listing may appear in a pop-up window. It is noted, however, that the browsing mode does not necessarily need to be switched when a portion of the objects are selected (i.e., the same browsing mode may be used in a subsequent selection). Furthermore, the listing may be continually displayed to the user in some embodiments such that triggering the listing is not necessary.

In some embodiments, the browser manager 206 may perform an analysis and determine which browsing mode is best for display of the selected objects and information. In these embodiments, no browsing mode selection is received from the user. For example, if a lot of objects are associated with locations, a geographical browsing mode may be utilized. Alternatively, a same browsing mode as a current browsing mode may be used when no browsing mode selection is provided.

The exemplary coordinator module 208 may be configured to map the selected portion of objects based on the browsing mode determined by the browser manager 206. In some embodiments, the functions of the coordinator module 208 are controlled by the browser manager 206. For instance, the selected portion of objects from the selection module 204 may be mapped to the graphical presentation (e.g., ZUI space) differently depending on which browsing mode is determined by the browser manager 206. From the example involving the five independent events above, the coordinator module 208 may map objects associated with the events geographically, chronologically, canonically, topically, or relationally depending on the browsing mode determined by the browser manager 206. In one embodiment, if no portion of the objects is selected, the coordinator module 208 may map all objects based on the browsing mode determined, or otherwise identified, by the browser manager 206. Furthermore, the coordinator module 208 may also be configured to map the objects based, at least in part, on various classifications of the objects in accordance with exemplary embodiments, as discussed in connection with the classification module 210. In one embodiment, the coordinator module 208 may be a part of the browser manager 206.

The classification module 210 may be configured to track classifications of objects based on the content associated therewith. These classifications may identify characteristics of the content associated with the objects. For example, an object associated with basketball may be classified as sports related. That object may also be classified as entertainment, by locale, and by content type. In some embodiments, a tag or metatag associated with each object may include classification information associated with that object. The classifications may also identify types of content associated with the objects. According to exemplary embodiments, the user may be able to determine which content types are included in the graphical presentation based on the classifications tracked by the classification module 210. The classifications may also determine the object or icon used to represent the content in graphical presentation. For example, video-type content may be represented by a movie reel-resembling-object.

The filter module 212 may be configured to filter the objects based on a content type associated with each of the objects. Nearly an endless amount of content types are possible. As mentioned herein, content types may range from photos and videos to articles and other text documents. Some embodiments may include more specific content types. In one example relating to a study Bible, content types such as Bible studies, genealogies, and Bible text and resources are included. Some examples may further include encyclopedia articles, dictionary definitions, and timeline events. Interactive maps, animations, and virtual tours may also be included as content types.

According to various embodiments, the user may determine one or more content types to be included in the graphical presentation by the interface module 202. In one embodiment, a list may be presented to the user to select desired content types. A user may initially specify a preference to restrict the graphical presentation to certain content types. For example, the user may wish to view only photographs. Accordingly, the user may specify a preference for photographs. As a result, the filtering module 212 will restrict the graphical presentation from providing content types other than photographs to the user.

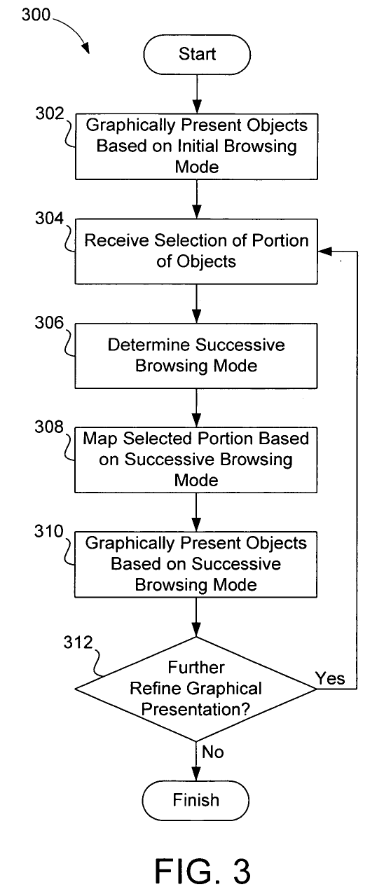

In FIG. 3, a flowchart of an exemplary method 300 for providing a zoomable user interface is presented. It is noteworthy that steps of the method 300 may be performed in varying orders. Additionally, various steps may be added or subtracted from the method 300 and still fall within the scope of the present invention.

In step 302, objects are presented graphically based on an initial browsing mode. The objects may include shapes, icons, thumbnail views, or other representations of the content. The initial browsing mode may determine how the objects are presented. For example, graphical presentations based on a topical browsing mode may present the objects grouped by topic. An initial view of the objects comprising the information of interest may show the objects as small icons on the display. According to some embodiments, the graphical presentation may be in the form of a ZUI space. The interface module 202 may perform step 302 in exemplary embodiments.

In step 304, a selection of a portion of the objects is received. According to various embodiments, the portion of the objects may be selected by a user using some selection device such as a mouse. In one example, the user may draw a bounding box around the portion of the objects. In another example, the user may click on each of the portion of the objects. The selection may be received by the selection module 204 in exemplary embodiments.

In step 306, a successive browsing mode is determined. According to some embodiments, the execution of step 304 may trigger a listing of browsing modes to appear such as in a pop-up window. In such embodiments, the user may then select the successive browsing mode. The browser manager 206 may then receive the selection of the successive browsing mode in accordance with some embodiments. Alternatively, however, the selection module 204 may receive a selection of the browsing mode and pass the selection on the browser manager 206. In further embodiments, the browser manager 206 may automatically determine the successive browsing mode. In some embodiments, the browser manager 206 may automatically determine the successive browsing mode based on the content types of the selected portion of objects. For example, if a lot of objects are associated with locations, a geographical browsing mode may be utilized. Furthermore, it is noted that step 306 may be optional according to some embodiments as the browsing mode may not be changed with every execution of step 304.

In step 308, the selected portion of objects from step 304 is mapped based on the successive browsing mode. The selected portion of objects may be mapped to the graphical presentation differently depending on which browsing mode is received or determined in step 306. According to some embodiments, the selected portion of objects may be mapped based, at least in part, on various classifications of the objects, as discussed in connection with the classification module 210. In addition, if step 306 is omitted, the selected portion of objects may be mapped based on the initial or current browsing mode. The coordinator module 208 may perform step 308 in exemplary embodiments. Alternatively, the browser manager 206 may perform step 308.

In step 310, the selected portion of the objects is graphically presented based on the successive browsing mode. Similarly as in step 302, the selected portion of the objects may include shapes, icons, thumbnail views, or other representations of the content. The successive browsing mode may determine how the portion of the objects is presented. The display may present more detailed versions of the object. For example, an initial object shown in step 302 may be only of an outline of Egypt. A subsequent display of objects in step 310 may show an outline of Cairo with books on the various pyramids positioned where the pyramids are located. Alternatively, the subsequent display in step 310 may show a timeline of the history of a particular Pharaoh. In exemplary embodiments, the interface module 202 may perform step 310 in exemplary embodiments.

It should be noted that the subsequent display is more than a mere zoom of the previous display. Instead, more details and information, refined by the selection process, is presented to the user. Additionally, the objects shown in the display may converted from a bitmap view to a vector-based view.

In step 312, a determination is made whether to further refine the graphical presentation. For example, a next selection of a portion of a browser may be received from the user. If further refinement of the graphical presentation is desired or required, the method 300 may be repeated starting at step 304. In alternative embodiments, the method 300 may be repeated starting at step 306.

To illustrate the method 300, an interactive Bible example is provided below. The interactive Bible may include content types such as Bible text, Bible commentaries, maps, photos, and a dictionary of biblical terms. All such content may be tagged or otherwise categorized according to canonical order, geographical location, chronology, and topic, for example. This tagging or categorization may be performed manually, by the classification module 210, or by a third-party in accordance with various embodiments. Such categorization may allow the user to browse the interactive Bible content in conjunction with, for example, a canonical browsing mode, a geographical browsing mode, a chronological browsing mode, or topical browsing mode, as described further below. The method 300 may be performed by the zoomable user interface engine 104 or by modules and elements therein in accordance with exemplary embodiments.

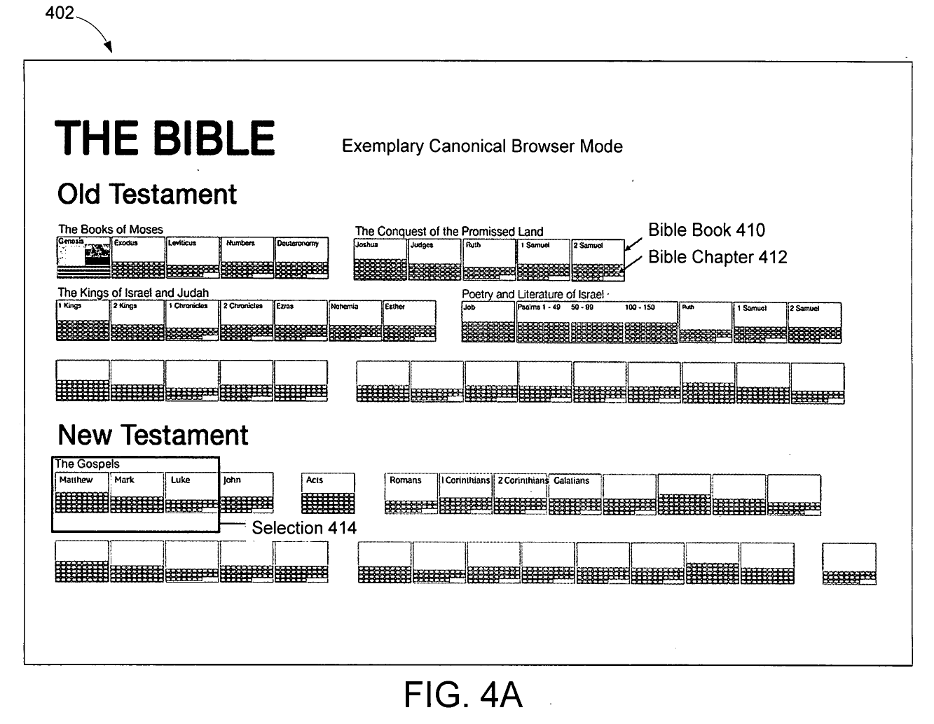

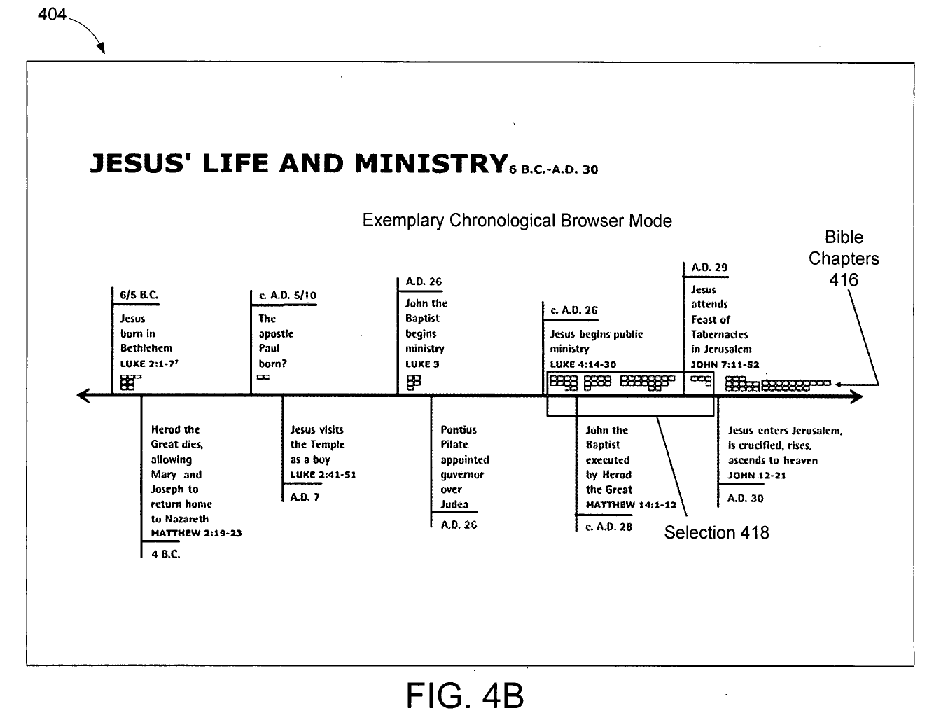

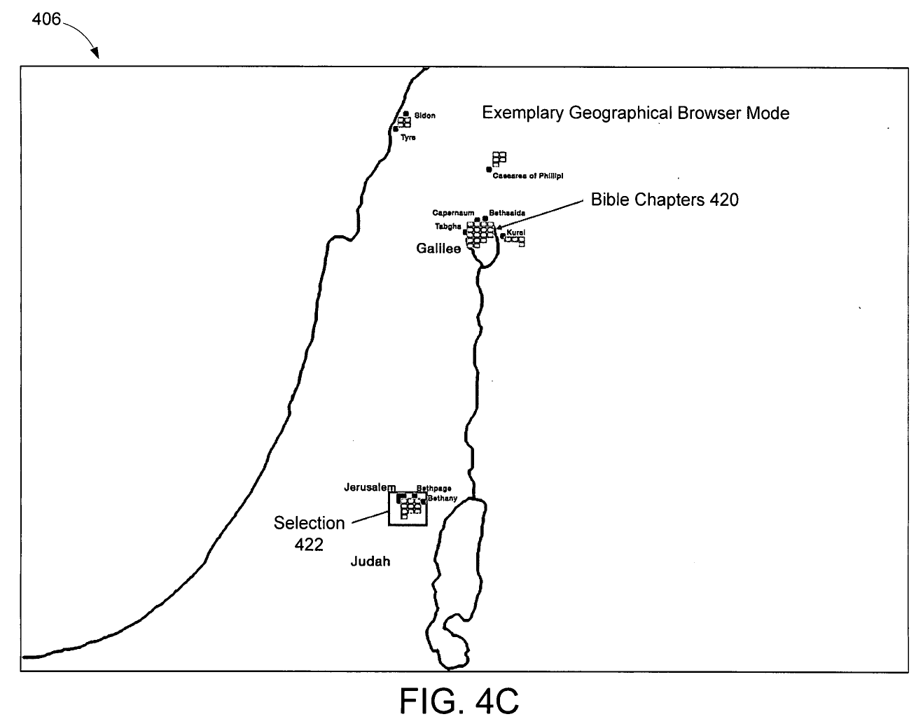

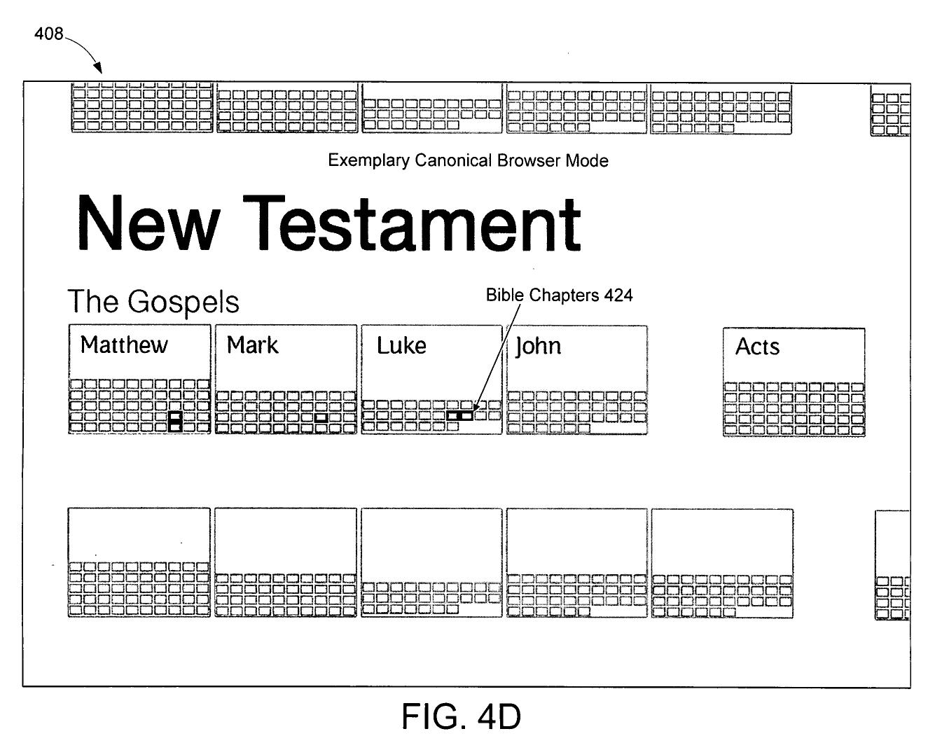

FIGS. 4A, 4B, 4C, and 4D illustrate graphical presentations based of various browsing modes for the interactive Bible example. More specifically, FIG. 4A depicts an exemplary canonical browsing mode based graphical presentation 402; FIG. 4B depicts an exemplary chronological browsing mode based graphical presentation 404; FIG. 4C depicts an exemplary geographical browsing mode based graphical presentation 406; and FIG. 4D depicts a zoomed-in view of the canonical browsing mode based graphical presentation 408. In this example, an assumption is made that the user's goal is to select Bible passages, photos, and maps that (1) are from the Synoptic Gospels (e.g., Matthews, Luke, or Mark), (2) refer to the ministry years of Jesus, and (3) took place in the Jerusalem area (e.g., Jerusalem, Bethany or Bethpage).

In FIG. 4A, the graphical presentation 402 comprises a number of objects representing content. In this case, the objects include shapes representing books and chapters of the Bible, such as Bible book 410 and Bible chapter 412. Since the user seeks to choose the Synoptic Gospels, an initial selection 414 is made. The initial selection 414 includes three Bible books (i.e., Matthew, Luke, and Mark) as well as the corresponding Bible chapters. The initial selection 414 may be received by the selection module 204. In order to refine the initial selection 414 to refer to the ministry years of Jesus, the chronological browsing mode may be invoked such as by the browser manager 206 based on selection by the user or by automatic analysis by the browser manager 206.

In FIG. 4B, steps 304-310 of the method 300 have been performed such that the graphical presentation 404 includes a timeline of the life and ministry of Jesus. The Bible chapters included in the initial selection 414, such as Bible chapters 416, are organized chronologically on the timeline. A second selection 418 includes the Bible chapters of the initial selection 414 that also correspond to the ministry years of Jesus. The geographical browsing mode may be invoked so as to further refine the second selection 418 to include only the content related to occurrences in the Jerusalem area based on a selection by the user or by automatic analysis by the browser manager 206.

In FIG. 4C, step 312 of the method 300 has been performed, followed by steps 304-310. The graphical presentation 406 includes a map of Jerusalem and the surrounding region. The objects representing the Bible chapters included in both the initial selection 414 and the second selection 418, such as Bible chapters 420, are placed on the map according to where the bible chapters took place. In some embodiments, objects representing Bible chapters that were not included in both the initial selection 414 and second selection 418 are placed accordingly, but are visually differentiated (e.g., filled in black) for distinction. In order to restrict the objects to only include those that took place near Jerusalem, a third selection 422 is made. A successive browsing mode may be selected or determined in conjunction with the browser manager 206.

In FIG. 4D, steps 304-312 of the method have been performed once again. The graphical presentation 408 returns to the canonical browsing mode. After the recursive execution of steps 304-312 of the method 300, objects that meet the user's search goal are highlighted, such as Bible chapters 424.

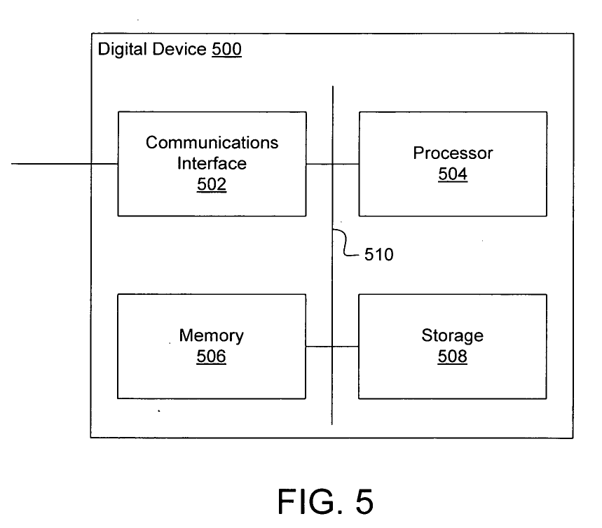

FIG. 5 shows an exemplary digital device 500. The digital device 500 may include the zoomable user interface engine 104 or the user devices 102 according to exemplary embodiments. The digital device 500 includes at least a communications interface 502, a processor 504, a memory 506, and storage 508, which are all coupled to a bus 510. The bus 510 provides communication between the communications interface 502, the processor 504, the memory 506, and the storage 508.

The processor 504 executes instructions. The memory 506 permanently or temporarily stores data. Some examples of memory 506 are RAM and ROM. The storage 508 also permanently or temporarily stores data. Some examples of the storage 508 are hard disks and disk drives.

The above-described components and functions can be comprised of instructions that are stored on a computer-readable storage medium. The instructions can be retrieved and executed by a processor (e.g., processor 504). Some examples of instructions are software, program code, and firmware. Some examples of storage media are memory devices, tapes, disks, integrated circuits, and servers. The instructions are operational when executed by the processor to direct the processor to operate in accord with the invention. Those skilled in the art are familiar with instructions, processor(s), and storage media.

The embodiments discussed herein are illustrative. As these embodiments are described with reference to illustrations, various modifications or adaptations of the methods and/or specific structures described may become apparent to those skilled in the art.

While the embodiments described herein are directed to various examples such as an interactive Bible, embodiments of the present invention may be applied to any type of content. Other fields where exemplary embodiments may be applied include, for example, semantic search engines and reference works for fields where the existing knowledge base may be highly classified and correlated (e.g., religions, law, medicine, and education). As such, exemplary embodiments may be applied to any type of content.

The present invention is described above with reference to exemplary embodiments. It will be apparent to those skilled in the art that various modifications may be made and other embodiments may be used without departing from the broader scope of the present invention. For example, any of the elements associated with the zoomable user interface engine 104 may employ any of the desired functionality set forth hereinabove. Therefore, there and other variations upon the exemplary embodiments are intended to be covered by the present invention.

What is claimed is:

1. A method for providing a zoomable user interface, comprising:
graphically presenting a first display of objects associated with content to a user, the first display based on a first browsing mode of a plurality of browsing modes;
receiving a selection of a portion of the objects of the graphical presentation;
determining a second browsing mode;
mapping the selected portion based on the second browsing mode; and
graphically presenting a second display comprising the selected portion based on the second browsing mode, the second display providing more detailed objects than the first display.

2. The method of claim 1, further comprising:
receiving a selection of a smaller portion of the objects in the second display;
determining a third browsing mode;
mapping the selected smaller portion based on the third browsing mode; and
graphically presenting a third display comprising the selected portion based on the third browsing mode.

3. The method of claim 1, wherein the objects comprise classifications based on the content associated therewith.

4. The method of claim 3, wherein the mapping is based, at least in part, on the classifications of the selected portion of objects.

5. The method of claim 1, further comprising triggering a listing of the plurality of browsing modes available to the user.

6. The method of claim 1, wherein determining the second browsing mode comprises receiving a selection of the second browsing mode.

7. The method of claim 1, where determining the second browsing mode comprises automatically determining the second browsing mode based at least on the selected portion.

8. The method of claim 1, further comprising filtering the objects based on a content type associated with each of the objects.

9. The method of claim 1, wherein a browsing mode of the plurality of browsing modes comprises a chronological browsing mode.

10. The method of claim 1, wherein a browsing mode of the plurality of browsing modes comprises a geographical browsing mode.

11. The method of claim 1, wherein a browsing mode of the plurality of browsing modes comprises a topical browsing mode.

12. The method of claim 1, wherein the more detailed objects comprise more comprehensive information than the first display of the objects.

13. The method of claim 1, wherein the more detailed objects comprise vector-based images.

14. A system for providing a zoomable user interface, the system comprising:
a processor; and
a storage medium comprising:
an interface module configured to graphically present objects associated with content to a user, the graphical presentation based on any one of a plurality of browsing modes;
a selection module configured to receive a selection of a portion of the objects of the graphical presentation;
a browser manager configured to determine a successive browsing mode; and
a coordinator module configured to map the selected portion based the successive browsing mode determined by the browser manager.

15. The system of claim 14, further comprising a classification module configured to track classifications of objects based on the content associated therewith.

16. The system of claim 15, wherein the coordinator module is further configured to map based, at least in part, on the classifications of the selected portion of objects.

17. The system of claim 14, wherein the browser manager is further configured to trigger a listing of the plurality of browsing modes to be provided to the user.

18. The system of claim 14, further comprising a filter module configured to filter the objects based on a content type associated with each of the objects.

19. A computer readable storage medium having embodied thereon a program, the program providing instructions operable by a processor for performing a method for providing a zoomable user interface, the method comprising:
graphically presenting objects associated with content to a user, the graphical presentation initially based on a first browsing mode of a plurality of browsing modes;
receiving a selection of a portion of the objects of the graphical presentation;
determining a second browsing mode;
mapping the selected portion based on the second browsing mode; and
graphically presenting the selected portion based on the second browsing mode.

20. The computer readable storage medium of claim 19, wherein the more detailed objects comprise more comprehensive information than the first display of the objects.
